(19) United States
(12) Patent Application Publication
(10) Pub. No.: US 2019/0342091 A1
(43) Pub. Date: Nov. 7, 2019

(54) System and method for analyzing properties within a real time or recorded transmissions

(71) Applicant: Geoffrey E. Korrub, Austin, TX (US)

(72) Inventor: Geoffrey E. Korrub, Austin, TX (US)

(21) Appl. No.: 16/398,470

(22) Filed: Apr. 30, 2019

Related U.S. Application Data
(60) Provisional application No. 62/667,804, filed on May 7, 2018.

(51) Int. Cl. H04L 9/08; H04L 9/32; H04L 9/06; H04L 29/08; G06N 20/00; H04L 29/12; H04L 1/00

(52) U.S. Cl. CPC H04L 9/0866; H04L 9/3263; H04L 9/0643; H04L 1/0091; G06N 20/00; H04L 61/2015; H04L 67/2804

(57) ABSTRACT

Wireless devices data transmissions are facilitated through an ever-increasing number of technologies and protocols. The wireless system for analyzing detecting and properties within a real-time or recorded transmission decomposes the variables within the control traffic protocol. This data may include fields common to the protocol that any identical device would share or more specific metadata such as a hash that is unique to a user or device. This decomposed metadata acts as a digital fingerprint and allows for devices and or users of the devices to be identified passively by the system.

### CROSS-REFERENCE TO RELATED APPLICATION

This application claims the benefit of U.S. Provisional Application No. 62/667,804, filed May 7, 2018, incorporated herein by reference.

### BACKGROUND OF THE INVENTION

### Field of the Invention

The present invention relates generally to computer networking techniques. More particularly, the invention provides a system and method for analyzing properties within a real time or recorded transmissions.

### Description of Related Art

Internet of Things (IoT) devices are now a part of every moment of our lives, but these products have short lifecycles and low price points. This is causing an issue with unmaintained IoT hardware that create security problems. These problems can be physical security when a camera is switched off or a door unlocked through a network hack. They can also be electronic as we have seen in BOT networks.

### BRIEF SUMMARY OF THE INVENTION

It is an object of the present invention to provide a system and method for analyzing properties within a real time or recorded transmissions.

The present invention looks to enable a resolution to prior issues by uniquely identifying devices down to model number, operating system and patch revision. This action is performed through a passive method that analyzes normal traffic.

Performed either through on a standalone hardware platform or integrated into an existing platform the passive one the IoT ID Engine enables a new level of understanding of the status of the IoT devices under watch without an agent installed on the target or an active communication performed by the Engine.

### BRIEF DESCRIPTION OF THE FIGURES

The novel features believed to be characteristic of the invention are set forth in the appended claims and claims yet to be filed. However, the invention itself, as well as preferred modes of use and further objectives and advantages thereof, will best be understood by reference to the following detailed description when read in conjunction with the accompanying Figures wherein:

FIG. 1 shows an Ethernet 802.11 (Wi-Fi) Medium Access Control (MAC), communication framework;

FIG. 2 shows a DHCP Communication Frame;

FIG. 3 is an example protocol handshakes; and

FIG. 4 shows a sample transmission in accordance with embodiment of the present invention.

### DETAILED DESCRIPTION OF THE PREFERRED EMBODIMENTS

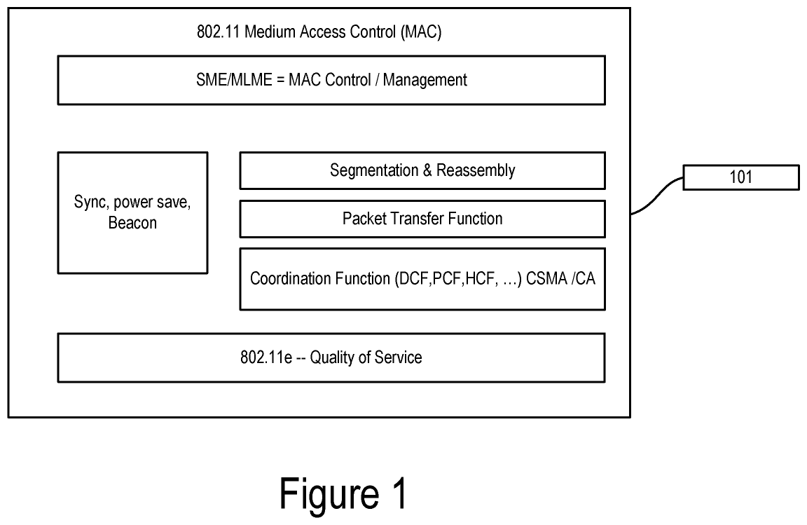

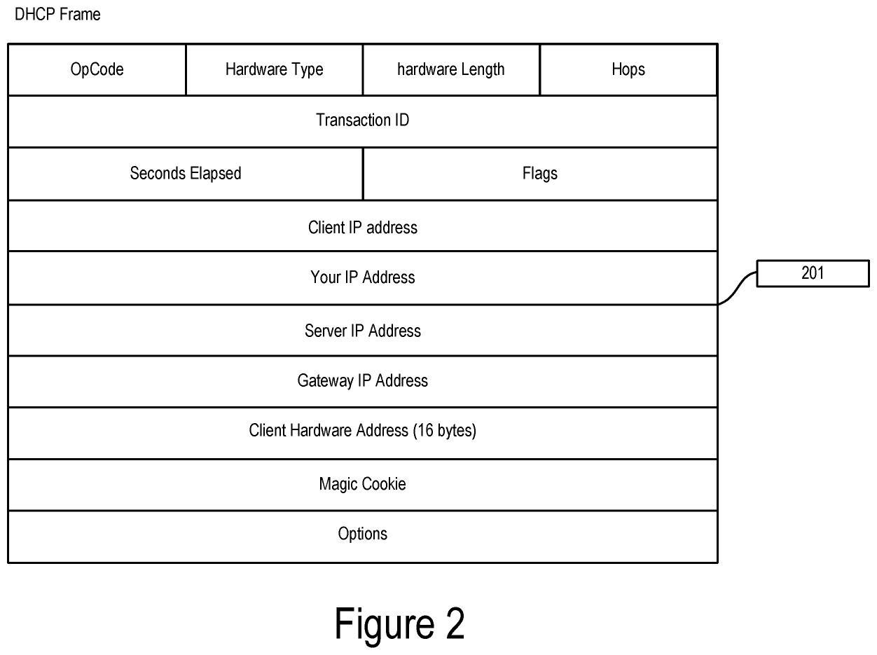

FIG. 1 shows an Ethernet 802.11 (Wi-Fi) Medium Access Control (MAC), communication framework. The sub-systems interact independently from each other depending on hardware capabilities but are essential within the protocol framework to setup, maintain and teardown sessions. For simplicity, embodiments given will focus on the MLME, FIG. 1 section of the 802.11 MAC framework. This should not exclude other protocols that share similar variable metadata such as by example DHPC, FIG. 2, in the option field of the protocol, 201.

The system and method works by passively monitoring the communications medium. In wired Ethernet, this is a mode referred to as promiscuous mode, for wireless the proper terminology is monitor mode, but is also called 802.11 Wiretap. Regardless of the terminology specifics the identification process will use at least in part a passively collected sampling for which it was not the intended exclusive recipient and for which it did not actively solicit a communication.

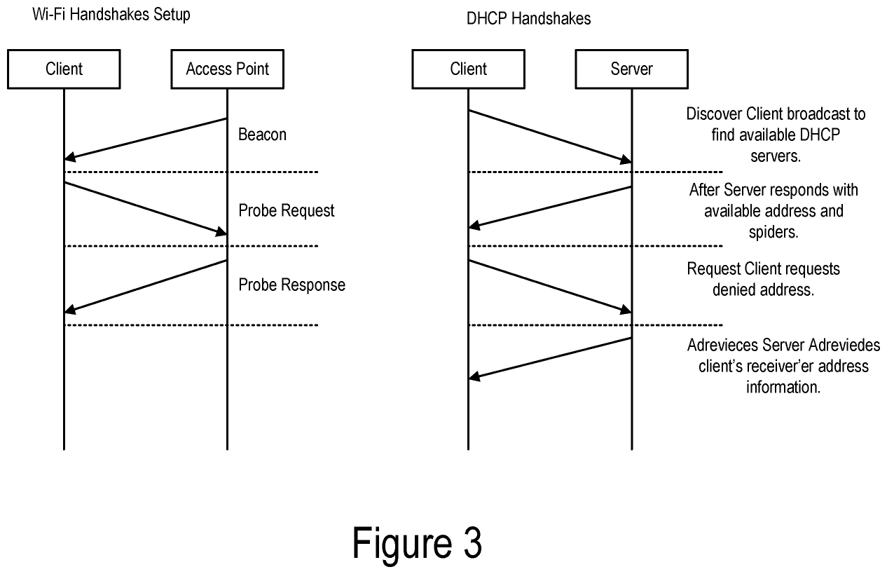

What makes this possible is that all significant communications protocols utilize some type of handshake that is predetermined within the standard. An example is shown for the Wi-Fi handshake in FIG. 3, and the DHCP protocol handshake, 302.

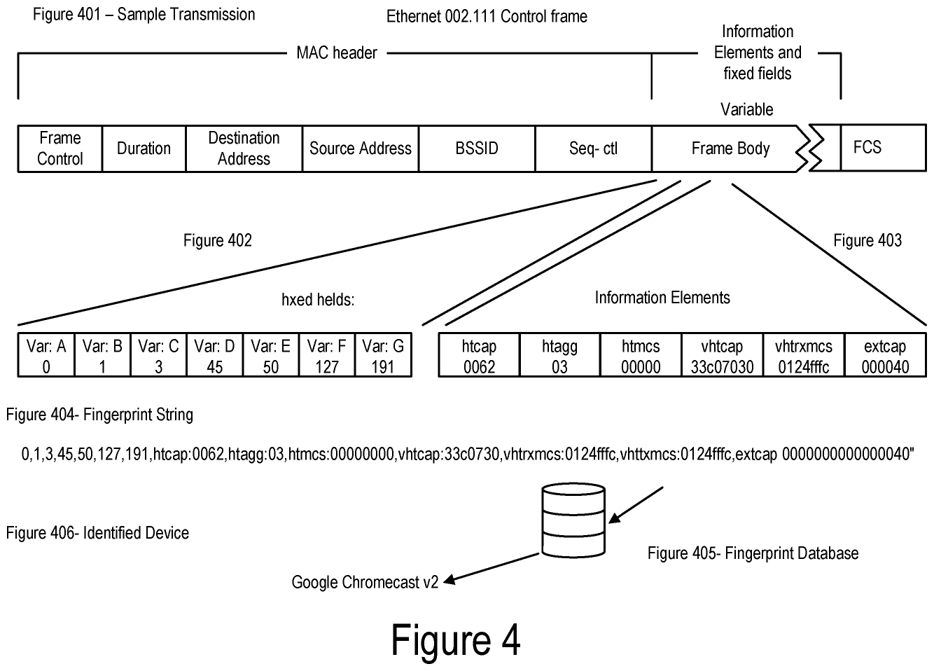

The system utilizes these transmissions, see FIG. 4, to extraction settings within the metadata of the packet. The metadata in the example of MLME consists of fixed fields, 402 and any number of Information Elements, 403. The values for these fields are then extracted and normalized to form a fingerprint out of the compilation of variables, see 404.

The system may also combine this discovered fingerprint string with any number of other protocols' metadata such as are contend within RTS, CTS, DNS, ARP, DHCP, ICMP and or any other protocol that carries identifiable metadata.

The system may also combine this discovered fingerprint string with any number of other supplemental heuristics data points.

With a fingerprint identified, the system may store or process the string along with supplemental information such as time, location, transmission power and or any other data that provides value and context.

With the fingerprint identified the system may also perform an action such as a lookup against a database, as at 405, for a device match, 406.

With the fingerprint identified or unknown to the identification process the system may also perform an action such as triggering an alert or installing a record into a database.

The MLME protocol contains fields such as “htcap”. This is a capabilities bitmask for the HT capabilities information element, see 403. Other elements currently include, htagg, htmcs, vhtcap, vhtrxmcs, and extcap, however the protocol is vendor expandable and an ever-increasing number of these variables will be available in future and are to be considered as included in this description.

These communications may be any number of protocols including Wired Ethernet, Wi-Fi, Zigbee, Bluetooth, Bluetooth low energy, GSM, GPRS, LTE or any other transmission technology that sets operating parameters for its transmission within metadata variables. Once a fingerprint is developed from these discovered these variables the fingerprint may be compared with fingerprints previously captured and cataloged to ascertain the most accurate identification of the device possible with ever expansive variables to track within the recorded transmissions it is possible that this technology can support ever more specific identification.

In one specific embodiment of the IoT ID Engine, the system looks at a Wi-Fi association handshake from an unknown wireless device using Ethernet 802.11, as in FIG. 3, 301. The device makes an association request to a wireless access point in its geographic area and within the request includes Tags, see 402, 403. These Tags contain device capabilities such as transmission power capabilities, supported data rates and many others. Further, the Tags may contain imbedded vendor identifying information such as OUI data for the device, its internal chipsets and system level software. The IoT Engine then extracts these Tags, and builds a fingerprint.

In yet another embodiment the IoT ID Engine, looks at a Wi-Fi association request from an unknown wireless device using ethernet 802.11. The device makes an association request to a wireless access point in its geographic area and within the request includes Tags. These Tags contain device capabilities such as transmission power capabilities, supported data rates and many others. Further the Tags may contain imbedded vendor identifying information such as OUI data for the device, its internal chipsets and system level software. The IoT Engine then extracts these Tags, and combines the information with additional supplemental information from other protocol level metadata such as RTS, CTS, DNS, ARP, DHCP variables, ICMP implementation details or any other additionally identifying protocol data and/or supplemental heuristics such as hostname, DNS-SD or other identifying network data may be incorporated into the fingerprinting process.

In yet another embodiment the IoT Engine extracts information from protocols metadata such as are contend within RTS, CTS, DNS, ARP, DHCP, ICMP and or any other protocol's that carries non-universal identifiable metadata and utilizes any single protocols variables or combines these protocols variables to build a fingerprint for a station through supplemental heuristics such as hostname, DNS-SD or other identifying network data may be incorporated into the fingerprinting process.

Once the fingerprinting process has been completed, the system may perform any number of actions including logging of the data on the system and or on a remote storage device. The system may also be configured to perform an action based on the capture of a devices signature without making any level of a local correlation or the system may perform some level of processing of the fingerprint locally.

In one example embodiment of the IoT ID Engine, the fingerprints are captured and stored on the system locally and summarized. The system is polled on a scheduled basis and uploads its summarized unprocessed data. In this embodiment de-duplication and time tacking are the only functions performed on the fingerprints and the external system(s) apply all logic.

In another example embodiment the IoT ID Engine provides local processing and correlation of fingerprints against a stored database that is synchronized with a network-based database. A system logic is follows as part of this processing and correlation which may include performing actions

While the invention has been described in connection with preferred embodiments, it is not intended to limit the scope of the invention to the particular forms set forth, but on the contrary, it is intended to cover such alternatives, modifications, and equivalents as may be included within the spirit and scope of the invention as defined by the appended claims, and claims that may issue.

What is claimed:

1. A method for analyzing properties within a real time or recoded transmissions, comprising:
collecting, using at least one sensor, RE data in one or more spectrums associated with the devices;
converting, using a processor, the collected RF data into a digital communication;
extracting, using a processor, metadata properties from the digital communications;
determining, using a processor, device details;
identifying, using any combination of a database local or remote machine learning, authentication system, and or remote information source(s) as specifically as possible based on the available metadata;
cataloging, using a database, session and device details for each device detected; and
exporting, using an external connection, data collected and or cataloged.

2. The method as claimed in claim 1 wherein the collected RF transmissions have no predetermined size.

3. The method claimed in claim 1 further comprising collecting any number or transmissions on any number of frequencies simultaneously only limited by the hardware's capabilities on which this method is implemented.

4. The method claimed in claim 1 further comprising collecting RF transmissions on any combination of storage methods including, on chip such as within CAM\TCAM or other local chip storage, in system memory such as in RAM and/or other high-speed volatile memory, and/or on system long term storage such as a hard disk, and/or exported to a remote system.

5. The method claimed in claim 1 further comprising converting the collected RF data into data frames based on an applied receiver/decoder method.

6. The method claimed in claim 5 further comprising specifying statically and/or, select dynamically receiver/decoder method based on RF spectrums and or receipt power and or observed previous pattern behavior to determine encoding utilized.

7. The method claimed in claim 6 further comprising applying any combination of receiver/decoder methods to any number of collected transmission simultaneously.

8. The method claimed in claim 1 further comprising extracting metadata through applying frame format.

9. The method of claimed in claim 1 further comprising extracting from the data frames metadata properties based frame format, both common properties such as speed offerings, and service capabilities as well as proprietary, uniquely identifying information such as an identifying hash or Certificate key.

10. The method claimed in claim 9 further comprising specifying statically and/or, select dynamically, the frame format in use based on RF spectrums detected on, and or the method utilized in claim 5 and or observed previous pattern behavior to determine frame format utilized.

11. The method claimed in claim 10 further comprising applying any combination of receiver/decoder methods to any number of collected transmission simultaneously.

12. The method claimed in claim 1 further comprising identifying devices by the “fingerprint” of their metadata, using any combination of a database local or remote, machine learning and or remote information source(s) as specifically as possible based on the available metadata.

13. The method claimed in claim 1 further comprising exporting data as collected, and/or at any point during execution of the method as described in claim 1, including any digests and/or other relevant data for system operations.

14. The method of claim 13 further comprising exporting to any number of external targets simultaneously in any number of formats through any number of transport methods for.

15. A system for analyzing properties within a real-time or recorded transmissions comprising:
a processor; a network communication interface; and
a memory coupled to the processor;
wherein the processor is configured to analyze metadata properties within a transmission for proposes of identifying the device with varying levels of specificity.

16. A wireless system for analyzing properties within a real time or recorded transmission as claimed in claim 15 wherein the system may collect locally through connected communication sensor array(s) and/or remotely through distributed sensor array(s) communicating over a communication network(s).

17. A wireless system for analyzing properties within a real time or recorded transmission as claimed in claim 15 where a database(s) of known fingerprints may be stored locally, and or over a network.

18. A wireless system for analyzing properties within a real time or recorded transmission as claimed in claim 17, where the fingerprint database(s) are used to identify devices based on the fingerprint as processes is compared either in whole or in part.

19. A wireless system for analyzing properties within a real time or recorded transmission as claimed in claim 18, where the fingerprint may also be further analyzed in place of or in conjunction with machine learning techniques.

20. A wireless system for analyzing properties within a real time or recorded transmission as claimed in claim 17 where the fingerprint database(s) may be updated with information dynamically as devices are discovered and identified.

21. A wireless system for analyzing properties within a real time or recorded transmission as claimed in claim 19 where machine learning techniques may be updated dynamically as devices are discovered and identified.
